(19) United States
(12) Patent Application Publication
(10) Pub. No.: US 2008/0199218 A1
(43) Pub. Date: Aug. 21, 2008

(54) ELECTROPHOTOGRAPHIC PHOTORECEPTOR AND ELECTROPHOTOGRAPHIC IMAGE FORMING METHOD AND APPARATUS USING THE PHOTORECEPTOR

(76) Inventors: Yasuo Suzuki, Fuji-shi (JP); Jun Aoto, Yokohama-shi (JP); Takehiko Kinoshita, Mishima-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/104,068

(22) Filed: Apr. 16, 2008

Related U.S. Application Data
(63) Continuation of application No. 09/679,480, filed on Oct. 5, 2000.

(30) Foreign Application Priority Data
Oct. 5, 1999 (JP) 11-284618
Oct. 5, 1999 (JP) 11-284760

(51) Int. Cl. G03G 15/00

(52) U.S. Cl. 399/159

(57) ABSTRACT

An electrophotographic photoreceptor including an electroconductive substrate, and a photosensitive layer formed overlying one side of the electroconductive substrate, wherein the photosensitive layer includes at least two charge generation materials which have spectral sensitivity in a different wavelength region, and wherein the photosensitive layer further includes an organic sulfur-containing compound.

### BACKGROUND OF THE INVENTION

1. Field of the Invention

The present invention relates to an electrophotographic photoreceptor, and to an electrophotographic image forming apparatus such as copiers, facsimiles and printers, which include a photoreceptor as an image carrier. In addition, the present invention relates to an electrophotographic image forming method.

2. Discussion of the Background

Currently, organic photoreceptors have been remarkably developed because of having high productivity and good cost efficiency. Among the organic photoreceptors, organic photoreceptors having a photosensitive layer including a charge generation material and a charge transporting material are widely used in the market.

On the other hand, electrophotographic image forming apparatus such as laser printers and digital copiers, which use a laser diode as a light source, have been developed and practically used in addition to the current image forming apparatus. In order to allow a photoreceptor to be commonly used for such various image forming apparatus, the photoreceptor is required to have high photosensitivities over a broad wavelength range including the visible region and the near infrared region.

In attempting to provide such a photoreceptor, methods in which two or more pigments which have spectral sensitivity in a different wavelength range are used as charge generation materials have been proposed in, for example, Japanese Laid-Open Patent Publications Nos. 63-148264, 1-177553 and 1-270060.

When two or more pigments are used as charge generation materials, the photosensitive wavelength range of the resultant photoreceptor widens. However, two or more energy levels are formed in the resultant charge generation layer, and therefore a combination of good characteristics of the pigments cannot be exhibited. Even when the formulation of such photoconductive layer is optimized, it is difficult to obtain a photoreceptor exhibiting an excellent combination of charge properties of high surface potential and low residual potential.

As to the light source used for image forming apparatus, laser diodes are typically used because of having advantages such as being small in size, low-priced, and easy to handle. The wavelength of the laser light emitted from the marketed laser diodes is limited to the near infrared region not less than 750 nm. Therefore, photoreceptors used for these image forming apparatus are required to have photosensitivity over at least a wavelength range of from 750 to 850 nm.

Squarilium pigments, phthalocyanine pigments, eutectic complexes of a pyrylium dye and a polycarbonate, pyrrolopyrrole, azo pigments and the like are known as the organic photosensitive materials having the requisite properties mentioned above. Among these pigments, phthalocyanine pigments are actively developed for electrophotographic photoreceptors because of having spectral absorption and photosensitivity over a wavelength range including a relatively long wavelength region, and in addition, by changing the center metal and the crystal form of the phthalocyanine pigments, various kinds of photosensitive materials can be prepared.

Up to now, ε-form copper phthalocyanine, X-form metal-free phthalocyanine, τ-form metal-free phthalocyanine, vanadyl phthalocyanine, titanyl phthalocyanine, etc. are known as phthalocyanine pigments having good photosensitivity. However, these phthalocyanine pigments are not satisfactory in the viewpoint of photosensitivity, charging ability and durability. Therefore phthalocyanine pigments in which these properties are improved are especially desired.

In Japanese Laid-Open Patent Publication No. 9-127711, it is attempted to solve the problems concerning charge properties by using an azo compound in combination with a phthalocyanine compound. However, with respect to the image qualities such as black spots, the publication refers to only the initial image properties. The present inventors found that such photoreceptor still has a problem such that image qualities deteriorate when the images are repeatedly produced for a long time.

In addition, Japanese Laid-Open Patent Publications Nos. 1-44945, 1-200261, 6-273953 and 7-295250 have disclosed techniques in which an organic sulfur-containing compound is added in a photosensitive layer as an antioxidant. It is described therein that by adding the organic sulfur-containing compound, increase of residual potential of the resultant photoreceptor and deterioration of characteristics of the resultant photoreceptor due to light irradiation can be controlled. However, there is no description as to whether image qualities can be improved by addition of the organic sulfur-containing compound.

In addition, corona charging has been widely used for charging a photoreceptor in electrophotographic image forming apparatus. When corona charging is repeatedly performed, ozone concentration in the surrounding air increases, resulting in environmental pollution. Therefore, recently a contact charging method is used for charging a photoreceptor. When a contact charging method is used, generation of ozone can be dramatically decreased. Therefore environmental pollution can be improved. However, contact charging methods have the following drawbacks:
(1) the photoreceptor tends to be abraded;
(2) the photoreceptor tends to be unevenly charged, resulting in production of images having uneven image density; and
(3) the photoreceptor tends to be broken down because a high voltage is directly applied thereto, resulting in production of undesired black spots images.

Further, when a photoreceptor provided in an image forming apparatus is repeatedly exposed to laser light for a long time or light (particularly ultraviolet light) in such a case that a photoreceptor unit or developer is changed or a jammed sheet is removed from the image forming apparatus, a problem which occurs is that the charge properties of the photoreceptor tend to deteriorate (hereinafter referred to as optical fatigue or an optical fatigue problem). It is also desired to solve this optical fatigue problem.

Because of these reasons, a need exists for a photoreceptor which has good durability and which can produce images having good image qualities even when charged by a contact charging method.

### SUMMARY OF THE INVENTION

Accordingly, an object of the present invention is to provide a photoreceptor which has good durability, good resistance to optical fatigue and stable charge properties and which can produce images having good image qualities even when used for a long time.

Another object of the present invention is to provide a photoreceptor which can produce good images even when charged by a contact charging method.

Yet another object of the present invention is to provide an image forming method and apparatus in which good images can be produced even when a contact charging method is used.

To achieve these objects, the present invention contemplates the provision of a photoreceptor having an electroconductive substrate, and a photosensitive layer including at least two kinds of charge generation materials which have spectral sensitivity in a different wavelength range, wherein the photosensitive layer further includes an organic sulfur-containing compound.

Preferably, the two kinds of charge generation materials include a phthalocyanine pigment and an asymmetric bisazo pigment having the following formula (I):

Cp₁-N═N-A-N═N-Cp₂ (I)

wherein A represents a divalent group including a carbon atom which connects the nitrogen atoms of the adjacent azo groups; and Cp₁ and Cp₂ represent a residual group of a coupler, wherein Cp₁ is different from Cp₂.

More preferably, the asymmetric azo compound has the following formula (II):

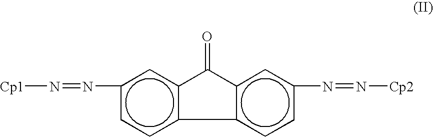

wherein Cp₁ and Cp₂ represent a residual group of a coupler, and wherein Cp₁ is different from Cp₂.

In addition, the phthalocyanine pigment includes τ-form or X-form metal-free phthalocyanine pigment.

Further, the organic sulfur-containing compound has the following formula (III)

S—(CH₂CH₂COOCₙH₂ₙ₊₁)₂ (III)

wherein n is an integer of from 8 to 25.

As another aspect of the present invention, an electrophotographic image forming apparatus is provided which includes at least a photoreceptor, a charging device, an imagewise light irradiation device, a reverse developing device, a transfer device, and a cleaning device, wherein the photoreceptor is the photoreceptor of the present invention.

Preferably, the charging device is a charging device which charges the photoreceptor while contacting the surface of the photoreceptor.

As yet another aspect of the present invention, a process cartridge is provided which can be detachably installed in an electrophotographic image forming apparatus and which includes at least a photoreceptor and one of a charging device, an imagewise light irradiating device, a reverse developing device, a transfer device, and a cleaning device, wherein the photoreceptor is the photoreceptor of the present invention.

These and other objects, features and advantages of the present invention will become apparent upon consideration of the following description of embodiments of the present invention in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like of corresponding parts throughout and wherein:

FIGS. 1 to 4 are schematic views illustrating the structure of embodiments of the photoreceptor of the present invention; and

FIG. 5 is a schematic view illustrating a main part of an embodiment of the image forming apparatus of the present invention.

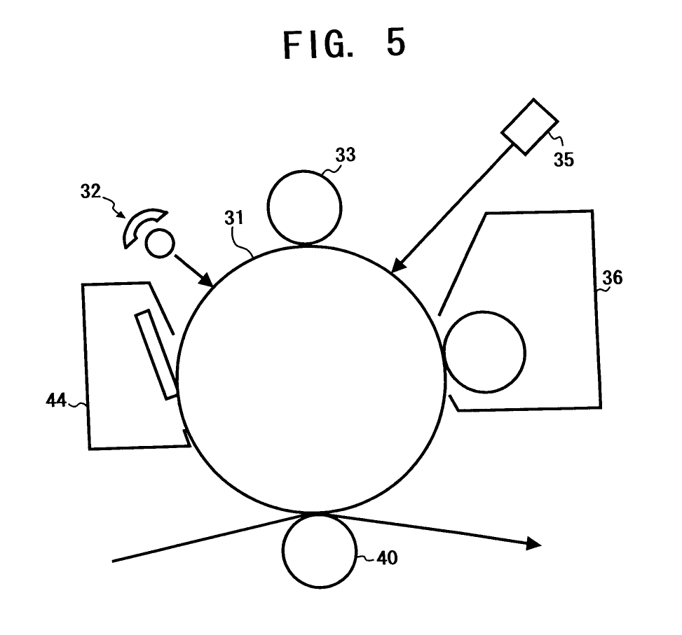

### DETAILED DESCRIPTION OF THE INVENTION

Generally, the present invention provides a photoreceptor having an electroconductive substrate, and a photosensitive layer including at least two kinds of charge generation materials which have spectral sensitivity in a different wavelength range, wherein the photosensitive layer further includes an organic sulfur-containing compound which serves as an antioxidant. When an organic sulfur-containing compound is used, the objects of the present invention mentioned above can be attained, i.e., a photoreceptor can be obtained which has good durability and good resistance to light fatigue. When an antioxidant such as hindered phenol type antioxidants, phosphoric acid type antioxidants, and photo-stabilizers, there is no improvement for image qualities and photo-deterioration, or only one thereof is improved.

The reason why an organic sulfur-containing antioxidant can improve both of image qualities and photo-deterioration is considered to be that the energy gap caused by employing two kinds of charge generation materials is affected by the organic sulfur-containing antioxidant, and therefore the trap level can be disappeared or decreased. In addition, since organic sulfur-containing antioxidants have good compatibility with binder resins and charge transport materials for use in the photosensitive layer, the organic sulfur-containing antioxidants do not separate out of the resins and charge transport materials. Therefore the effects can be effectively enhanced.

Among the organic sulfur-containing antioxidants, compounds having the following formula (III) are preferable.

S—(CH₂CH₂COOCₙH₂ₙ₊₁)₂ (III)

wherein n is an integer of from 8 to 25.

The reason why the compounds having formula (III) are preferable is not clear, but is considered to be that the compounds have an ester group and therefore the compounds are moderately compatible with other materials included in the photosensitive layer.

When n is less than 8, the resultant compounds tend to sublimate. When n is greater than 25, the compatibility tends to deteriorate, resulting in separation of the resultant compounds from the materials included in the photosensitive layer.

The organic sulfur compounds for use in the photosensitive layer of the photoreceptor of the present invention are not particularly limited if they are an antioxidant including a sulfur atom. Specific examples of the organic sulfur compounds include the compounds as shown in Tables 1 and 2, but are not limited thereto.

TABLE 1

| | |
|---|---|
| S—(CH2CH2COOH)2 | (III-1) |
| S—(CH2CH2COOC8H17)2 | (III-2) |
| S—(CH2CH2COOC12H25)2 | (III-3) |
| S—(CH2CH2COOC13H27)2 | (III-4) |
| S—(CH2CH2COOC14H29)2 | (III-5) |
| S—(CH2CH2COOC18H37)2 | (III-6) |
| S—(CH2CH2COOC22H45)2 | (III-7) |

TABLE 2

| | |
|---|---|
| | (S-1) |
| 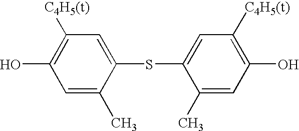 | |
| | (S-2) |
| 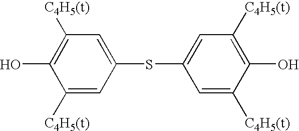 | |
| | (S-3) |
| 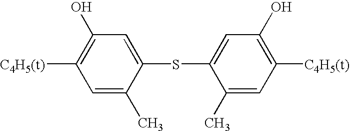 | |

In the present invention, an asymmetric disazo pigment having very high sensitivity and formula (I) mentioned above is used as a charge generation material.

The asymmetric bisazo pigment can be prepared by reacting a corresponding diazonium salt compound with a coupler corresponding to group Cp₁ and then reacting the product with a coupler corresponding to group Cp₂. Alternatively, the asymmetric bisazo pigment can be prepared by preparing and isolating a diazonium compound coupled with group Cp₁ (or Cp₂), and then reacting the coupled diazonium compound with a coupler corresponding to group Cp₂ (or Cp₁).

Specific examples of groups A, Cp₁ and Cp₂ include groups as shown in Tables 3 to 11.

Specific examples of group A include the groups as shown in Table 3 and 4.

TABLE 3

| No. | Formula |
|---|---|
| A-1 | 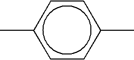 |
| A-2 | 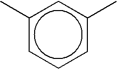 |
| A-3 | 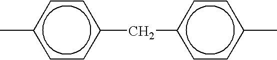 |
| A-4 | 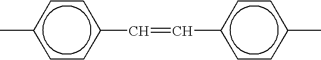 |
| A-5 | 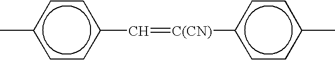 |
| A-6 | 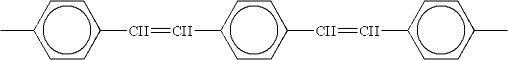 |
| A-7 | 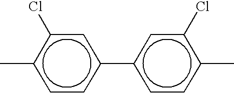 |
| A-8 | 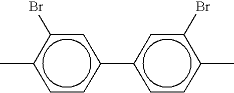 |
| A-9 | 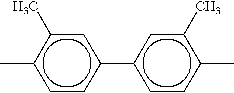 |
| A-10 | 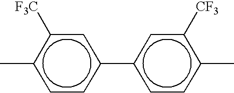 |
| A-11 | 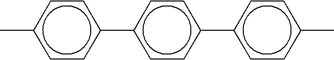 |
| A-12 | 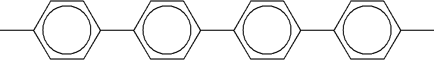 |
| A-13 | 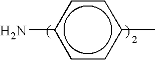 |
| A-14 | 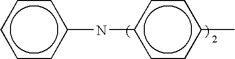 |
| A-15 | 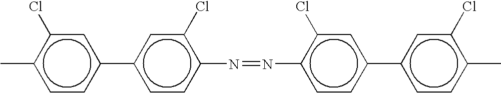 |
| A-16 | 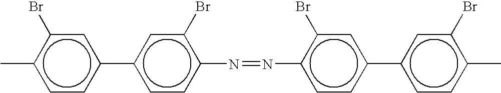 |
| A-17 | 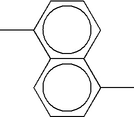 |

TABLE 4

| No. | Formula |
|---|---|
| A-18 | 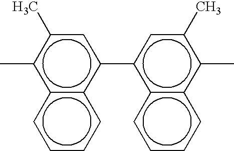 |
| A-19 | 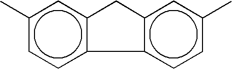 |
| A-20 | 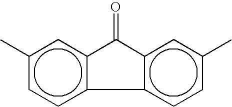 |
| A-21 | 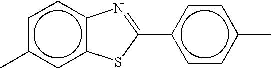 |
| A-22 | 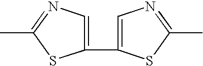 |
| A-23 | 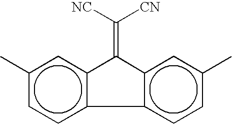 |
| A-24 | 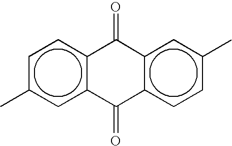 |
| A-25 | 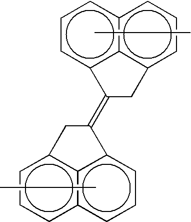 |
| A-26 | 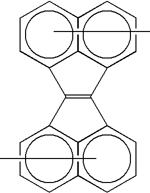 |
| A-27 | 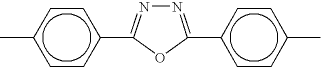 |
| A-28 | 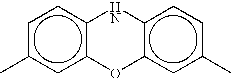 |
| A-29 | 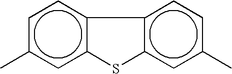 |
| A-30 | 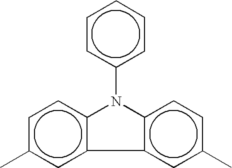 |

TABLE 5
Specific examples of groups Cp1 and Cp2 include groups
having the following formula (C1):

| | |
|---|---|
| | (C1) |
| 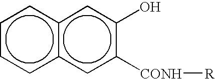 | |

| No. | R |
|---|---|
| C1-1 | phenyl |
| -2 | 2-chlorophenyl |
| -3 | 3-chlorophenyl |
| -4 | 4-chlorophenyl |
| -5 | 2-nitrophenyl |
| -6 | 3-nitrophenyl |
| -7 | 4-nitrophenyl |
| -8 | 2-trifluoromethyl |
| -9 | 3-trifluoromethyl |
| -10 | 4-trifluoromethyl |
| -11 | 2-methylphenyl |
| -12 | 3-methylphenyl |
| -13 | 4-methylphenyl |
| -14 | 2-methoxyphenyl |
| -15 | 3-methoxyphenyl |
| -16 | 4-methoxyphenyl |
| -17 | 2-cyanophenyl |
| -18 | 3-cyanophenyl |
| -19 | 4-cyanophenyl |
| -20 | 1-naphthyl |
| -21 | 2-anthraquinolyl |
| -22 | 3,5-bistrifluoromethylphenyl |
| -23 | 4-pyrazolyl |
| -24 | 2-thiazolyl |
| -25 | 4-carboxyl-2-thiazolyl |
| -26 | 2-pyridyl |
| -27 | 2-pyrimidinyl |
| -28 | 2-carbazolyl |
| -29 | 2-quinolyl |

TABLE 6
Specific examples of groups Cp1 and Cp2 include groups
having the following formula (C2):

| | |
|---|---|
| | (C2) |
| 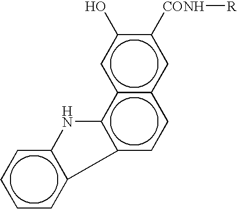 | |

| No. | R |
|---|---|
| C2-1 | phenyl |
| -2 | 2-chlorophenyl |
| -3 | 3-chlorophenyl |
| -4 | 4-chlorophenyl |
| -5 | 2-nitrophenyl |
| -6 | 3-nitrophenyl |
| -7 | 4-nitrophenyl |
| -8 | 2-trifluoromethyl |
| -9 | 3-trifluoromethyl |
| -10 | 4-trifluoromethyl |
| -11 | 2-methylphenyl |
| -12 | 3-methylphenyl |
| -13 | 4-methylphenyl |
| -14 | 2-methoxyphenyl |
| -15 | 3-methoxyphenyl |
| -16 | 4-methoxyphenyl |
| -17 | 2-cyanophenyl |
| -18 | 3-cyanophenyl |
| -19 | 4-cyanophenyl |
| -20 | 1-naphthyl |
| -21 | 2-anthraquinolyl |
| -22 | 3,5-bistrifluoromethylphenyl |
| -23 | 4-pyrazolyl |
| -24 | 2-thiazolyl |
| -25 | 4-carboxyl-2-thiazolyl |
| -26 | 2-pyridyl |
| -27 | 2-pyrimidinyl |
| -28 | 2-carbazolyl |
| -29 | 2-quinolyl |

TABLE 7
Specific examples of groups Cp1 and Cp2 include groups
having the following formula (C3):

| | |
|---|---|
| | (C3) |
| 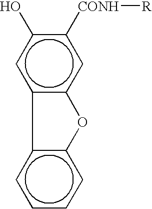 | |

| No. | R |
|---|---|
| C1-1 | phenyl |
| -2 | 2-chlorophenyl |
| -3 | 3-chlorophenyl |
| -4 | 4-chlorophenyl |
| -5 | 2-nitrophenyl |
| -6 | 3-nitrophenyl |
| -7 | 4-nitrophenyl |
| -8 | 2-trifluoromethyl |
| -9 | 3-trifluoromethyl |
| -10 | 4-trifluoromethyl |
| -11 | 2-methylphenyl |
| -12 | 3-methylphenyl |
| -13 | 4-methylphenyl |
| -14 | 2-methoxyphenyl |
| -15 | 3-methoxyphenyl |
| -16 | 4-methoxyphenyl |
| -17 | 2-cyanophenyl |
| -18 | 3-cyanophenyl |
| -19 | 4-cyanophenyl |
| -20 | 1-naphthyl |
| -21 | 2-anthraquinolyl |
| -22 | 3,5-bistrifluoromethylphenyl |
| -23 | 4-pyrazolyl |
| -24 | 2-thiazolyl |
| -25 | 4-carboxyl-2-thiazolyl |
| -26 | 2-pyridyl |
| -27 | 2-pyrimidinyl |
| -28 | 2-carbazolyl |
| -29 | 2-quinolyl |

TABLE 8
Specific examples of groups Cp1 and Cp2 include groups
having the following formula (C4):

| | |
|---|---|
| | (C4) |
| 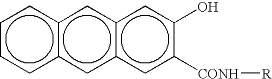 | |

| No. | R |
|---|---|
| C4-1 | Phenyl |
| -2 | 2-chlorophenyl |
| -3 | 3-chlorophenyl |
| -4 | 4-chlorophenyl |
| -5 | 2-nitrophenyl |
| -6 | 3-nitrophenyl |
| -7 | 4-nitrophenyl |
| -8 | 2-trifluoromethyl |
| -9 | 3-trifluoromethyl |
| -10 | 4-trifluoromethyl |
| -11 | 2-methylphenyl |
| -12 | 3-methylphenyl |
| -13 | 4-methylphenyl |
| -14 | 2-methoxyphenyl |
| -15 | 3-methoxyphenyl |
| -16 | 4-methoxyphenyl |
| -17 | 2-cyanophenyl |
| -18 | 3-cyanophenyl |
| -19 | 4-cyanophenyl |
| -20 | 1-naphthyl |
| -21 | 2-anthraquinolyl |
| -22 | 3,5-bistrifluoromethylphenyl |
| -23 | 4-pyrazolyl |
| -24 | 2-thiazolyl |
| -25 | 4-carboxyl-2-thiazolyl |
| -26 | 2-pyridyl |
| -27 | 2-pyrimidinyl |
| -28 | 2-carbazolyl |
| -29 | 2-quinolyl |

TABLE 9
Specific examples of groups Cp1 and Cp2 include groups
having the following formula (C5):

| | |
|---|---|
| | (C5) |
| 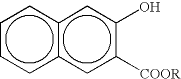 | |

| No. | R |
|---|---|
| C5-1 | methyl |
| -2 | ethyl |
| -3 | propyl |
| -4 | isopropyl |
| -5 | butyl |
| -6 | isobutyl |
| -7 | sec-butyl |
| -8 | tert-butyl |
| -9 | pentyl |
| -10 | isoamyl |
| -11 | hexyl |
| -12 | heptyl |
| -13 | octyl |
| -14 | capryl |
| -15 | nonyl |
| -16 | decyl |
| -17 | undecyl |
| -18 | lauryl |
| -19 | tridecyl |
| -20 | pentadecyl |

TABLE 10
Specific examples of groups Cp1 and Cp2 include groups
having the following formula (C6):

| | |
|---|---|
| | (C6) |
| 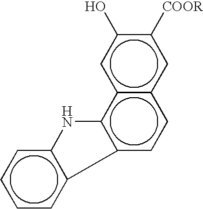 | |

| No. | R |
|---|---|
| C6-1 | methyl |
| -2 | ethyl |
| -3 | propyl |
| -4 | isopropyl |
| -5 | butyl |
| -6 | isobutyl |
| -7 | sec-butyl |
| -8 | tert-butyl |
| -9 | pentyl |
| -10 | isoamyl |
| -11 | hexyl |
| -12 | heptyl |
| -13 | octyl |
| -14 | capryl |
| -15 | nonyl |
| -16 | decyl |
| -17 | undecyl |
| -18 | lauryl |
| -19 | tridecyl |
| -20 | pentadecyl |

TABLE 11
Specific examples of groups Cp1 and Cp2 include groups
having the following formula (C7-1), (C7-2) or (C8):

| No. | |
|---|---|
| C7-1 | 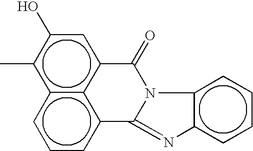 |
| C7-2 | 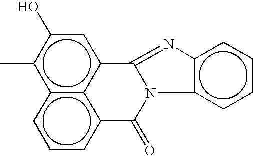 |
| C8 | 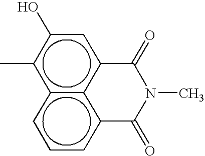 |

Among these asymmetric disazo pigments, compounds having formula (II), i.e., compounds having the fluorenone skeleton of A-20 as shown in Table 4, are especially preferable because of having high sensitivity and good charge stability.

Known phthalocyanine pigments for use in the electrophotographic photoreceptors can be used in the photosensitive layer of the photoreceptor of the present invention. However, it is preferable to use at least one of an X-form metal-free phthalocyanine pigment and a τ-form metal-free phthalocyanine pigment because the resultant photoreceptor has good sensitivity and good charge properties. The reason is not clear, but is considered to be that the HOMO level of the X-form and τ-form metal-free phthalocyanine pigments is near the HOMO level of the asymmetric bisazo pigments mentioned above, and by mixing them they interact with each other. Therefore the sensitivity of the resultant photoreceptor is effectively enhanced and in addition good charge properties such as low residual potential and high surface potential can be maintained even when the photoreceptor is used for a long time.

The τ-form metal-free phthalocyanine pigment has an X-ray diffraction spectrum in which main peaks are observed at Bragg 2θ angle of 7.6°, 9.2°, 16.8°, 17.4°, 20.4°, 20.9°, 21.7° and 27.6° (the tolerance of each angle is ±0.2°) when a specific X-ray of Cu-Kα having a wavelength of 1.541 Å irradiates the pigments. The τ-form metal-free phthalocyanine pigment can be prepared by a method described in, for example, Japanese Laid-Open Patent Publications Nos. 58-182639 and 60-19154.

The X-form metal-free phthalocyanine pigment has an X-ray diffraction spectrum in which main peaks are observed at Bragg 2θ angle of 7.5°, 9.1°, 16.7°, 17.3°, 22.3° and 28.8° (the tolerance of each angle is ±0.2°) when a specific X-ray of Cu-Kα irradiates the pigments. The X-form metal-free phthalocyanine pigments can be prepared by a method described in, for example, U.S. Pat. Nos. 3,357,989 and 3,594,163, and Japanese Patent Publication No. 49-4338 and Japanese Laid-Open Patent Publication No. 60-243089.

The photoreceptor of the present invention will be explained in detail referring to drawings.

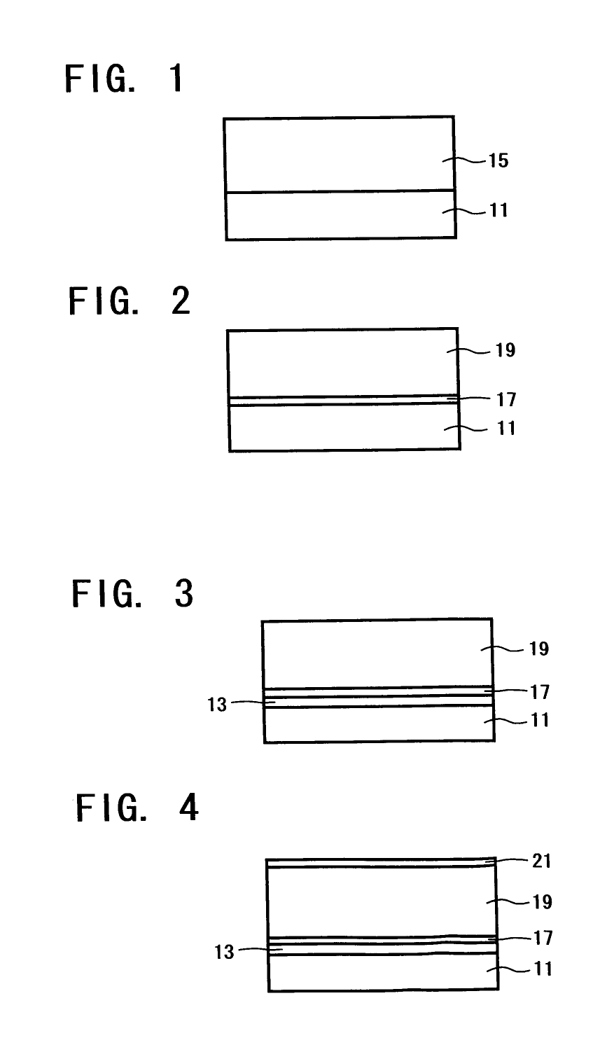

FIG. 1 is a schematic view illustrating a cross section of an embodiment of the photoreceptor of the present invention. In FIG. 1, the photoreceptor has a single-layer photoreceptor in which a photosensitive layer 15 including two or more kinds of charge generation materials is formed on an electroconductive substrate 11.

FIG. 2 is a schematic view illustrating a cross section of another embodiment of the photoreceptor of the present invention. In FIG. 2, a charge generation layer 17 and a charge transport layer 19, which serve as a photosensitive layer, are formed on an electroconductive substrate 11 in this order.

FIG. 3 is a schematic view illustrating a cross section of yet another embodiment of the photoreceptor of the present invention. In FIG. 3, an intermediate layer 13 is formed between a charge generation layer 17 and an electroconductive substrate 11.

FIG. 4 is a schematic view illustrating a cross section of a further embodiment of the photoreceptor of the present invention. In FIG. 4, a protective layer 21 is formed on a charge transport layer 19.

The photoreceptors having a structure as shown in FIG. 2, 3 or 4 (i.e., functionally-separated photoreceptors) will be explained in detail.

Suitable substrates for use as the electroconductive substrate 11 of the photoreceptor of the present invention includes a material having a volume resistivity less than 10¹⁰ Ω·m. Specific examples of such substrates include drums and sheets which are made of plastics and paper and whose surfaces are coated with a metal such as aluminum, nickel, chrome, nickel-chrome alloys, copper, silver, gold, platinum and the like, or a metal oxide such as tin oxide and indium oxide, by a vacuum evaporation method or a sputtering method. In addition, a plate of a metal such as aluminum, aluminum alloys, nickel stainless steel and the like and a tube which is made, for example, by preparing a rough tube of a metal mentioned above by an extruding or a drawing method and then subjecting the surface of the rough tube to a cutting, super finishing and/or polishing treatment can also be used. Further, an endless nickel belt and stainless belt, which are disclosed in, for example, Japanese Laid-Open Patent Publication No. 52-36016, can also be used as the electroconductive substrate 11.

In addition, substrates, which are made by coating on the above-mentioned supporters a coating liquid in which an electroconductive powder is dispersed in a binder resin solution, can also be used as the electroconductive substrate 11. Specific examples of the electroconductive powder include carbon black, acetylene black, metal powders such as aluminum, nickel, iron, nickel-chromium alloys, copper, zinc, and silver; and metal oxides such as electroconductive titanium oxides, electroconductive tin oxides, ITO and the like. Specific examples of such a binder resin include thermoplastic resins, thermosetting resins or photo-crosslinking resins such as polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyarylate resins, phenoxy resins, polycarbonate resins, cellulose acetate resins, ethyl cellulose resins, polyvinyl butyral resins, polyvinyl formal resins, polyvinyl toluene resins, poly-N-vinylcarbazole resins, acrylic resins, silicone resins, epoxy resins, melamine resins, urethane resins, phenolic resins, alkyd resins and the like. The electroconductive layer can be formed by coating a coating liquid in which one or more of the electroconductive powders and one or more of the binders resin are dispersed or dissolved in a proper solvent such as tetrahydrofuran, dichloromethane, 2-butanone, and toluene.

Further, substrates, in which an electroconductive layer is formed on a cylindrical supporter using a heat shrinkable tube in which one or more of the electroconductive powders mentioned above are included in a resin such as polyvinyl chloride, polypropylene, polyester, polystyrene, polyvinylidene chloride, polyethylene, chlorinated rubbers, and fluorine-containing resins, can also be used as the electroconductive substrate 11.

In the photoreceptor of the present invention, the charge generation layer 17 includes at least two kinds of charge generation materials, which preferably include an asymmetric bisazo pigment and a phthalocyanine pigment and which are dispersed in one or more binder resin, if desired.

As the charge generation material, phthalocyanine pigments such as titanyl phthalocyanine, vanadyl phthalocyanine, copper phthalocyanine, hydroxy gallium phthalocyanine, and metal-free phthalocyanine; monoazo pigments, bisazo pigments, asymmetric bisazo pigments, trisazo pigments, tetraazo pigments, pyrrolopyrrole pigments, anthraquinone pigments, perylene pigments, polycyclic pigments, indigo pigments, squarilium pigments, and other materials known as charge generation materials can be used.

Among these materials, asymmetric bisazo pigments and phthalocyanine pigments are preferably used. Asymmetric pigments impart high sensitivity over a wavelength range of the visible region to the resultant photoreceptor, and phthalocyanine pigments impart high sensitivity over a wavelength range of the near infrared region to the resultant photoreceptor. In addition, both of asymmetric bisazo pigments and phthalocyanine pigments have good dispersibility, and therefore the sensitization effects can be effectively exerted.

The charge generation layer 17 can be prepared, for example, by the following method:
(1) the charge generation materials mentioned above are dispersed in a proper solvent optionally together with a binder resin using a ball mill, an attritor, a sand mill, an ultrasonic dispersion machine or the like to prepare a coating liquid; and
(2) the coating liquid is coated on an electroconductive substrate 11 or an intermediate layer 13 formed on an electroconductive substrate 11, and then dried to form a charge generation layer 17.

Suitable binder resins for use in the charge generation layer 17 include polyamide resins, polyurethane resins, epoxy resins, polyketone resins, polycarbonate resins, silicone resins, acrylic resins, polyvinyl formal resins, polyvinyl butyral resins, polyvinyl benzal resins, polyester resins, phenoxy resins, vinyl chloride-vinyl acetate copolymers, polyvinyl acetate resins, polyvinyl pyridine resins, cellulose resins, casein, polyvinyl alcohol resins, polyvinyl pyrrolidone resins, and the like resins. Among these resins, polyvinyl butyral resins are preferably used.

The ratio of the asymmetric bisazo pigment to the phthalocyanine pigment in the charge generation layer 17 is preferably from 1:5 to 5:1 by weight so that the resultant photoreceptor can maintain good panchromatic photosensitivity, good charge properties even when used for a long time or exposed to light before image forming operations.

The ratio of the charge generating materials to the binder resin in the charge generation layer 17 is preferably from 100:10 to 100:500 by weight, and more preferably from to 100:25 to 100:300 by weight.

The thickness of the charge generation layer 17 is from 0.01 to 5 μm, and preferably from 0.1 to 2 μm. Suitable solvents for use in the charge generation layer coating liquid include isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, ligroin, and the like solvents. As the coating method, dip coating methods, nozzle coating methods, spinner coating methods, ring coating methods and the like methods can be used.

The charge transport layer 19 can be formed by coating on the charge generation layer 17 a coating liquid in which a charge transport material and a binder resin are dissolved or dispersed in a proper solvent, and drying the coated liquid. Additives such as plasticizers, leveling agents and antioxidants can be included in the coating liquid if desired.

The charge transport materials are classified into positive-hole transport materials and electron transporting materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-indeno-4H-indeno[1,2-b]thiophene-4-one, 1,3,7-trinitrodibenzothiophene-5,5-dioxide, benzoquinone derivatives and the like.

Specific examples of the positive-hole transport materials include known materials such as poly-N-vinyl carbazole and its derivatives, poly-γ-carbazolylethylglutamate and its derivatives, pyrene-formaldehyde condensation products and their derivatives, polyvinylpyrene, polyvinylphenanthrene, polysilane, oxazole derivatives, imidazole derivatives, monoaryl amine derivatives, diaryl amine derivatives, triaryl amine derivatives, stilbene derivatives, α-phenylstilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives, positive-hole transport polymer materials, and the like.

Specific examples of the binder resins for use in the charge transport layer 19 include thermoplastic resins and thermosetting resins such as polystyrene resins, styrene-acrylonitrile copolymers, styrene-butadiene copolymers, styrene-maleic anhydride copolymers, polyvinylidene chloride resins, polyarylate resins, phenoxy resins, polycarbonate resins, cellulose acetate resins, ethyl cellulose resins, polyvinyl butyral resins, polyvinyl formal resins, polyvinyl toluene resins, poly-N-vinylcarbazole resins, acrylic resins, silicone resins, epoxy resins, melamine resins, urethane resins, phenolic resins, alkyd resins, polycarbonate copolymers disclosed in Japanese Laid-Open Patent Publications Nos. 5-158250 and 6-51544, and the like resins.

The concentration of the charge transporting material in the charge transport layer 19 is from 20 to 300 parts by weight, and preferably from 40 to 150 parts by weight, per 100 parts by weight of the binder resin included in the charge transport layer 19. In addition, the thickness of the charge transport layer 19 is preferably from 5 to 50 μm.

Specific examples of the solvent for use in the charge transport layer coating liquid include tetrahydrofuran, dioxane, toluene, monochlorobenzene, dichloroethane, dichloromethane, cyclohexanone, methyl ethyl ketone, acetone and the like solvents.

The charge transport layer 19 may include a leveling agent. Specific examples of the leveling agent include silicone oils such as dimethyl silicone oils and methyl phenyl silicone oils, and polymers and oligomers including a perfluoroalkyl group in their side chains. The concentration of the leveling agent in the charge transport layer 19 is from 0 to 1 part by weight per 100 parts by weight of the binder resin included in the charge transport layer 19.

In the single-layer type photoreceptor of the present invention as shown in FIG. 1, an organic sulfur-containing antioxidant is included in the photosensitive layer 15. The concentration of the organic sulfur-containing antioxidant in the photosensitive layer 15 is preferably from 0.5 to 20 parts by weight per 100 parts by weight of the charge generation material included in the photosensitive layer 15, and from 0.2 to 10 parts by weight per 100 parts by weight of the charge transport material included in the photosensitive layer 15.

In the functionally-separated photoreceptor of the resent invention as shown in FIGS. 2 to 4, an organic sulfur-containing antioxidant can be included in the charge generation layer 17 and/or the charge transport layer 19. When an organic sulfur-containing antioxidant is included in the charge generation layer 17, the concentration of the antioxidant in the charge generation layer 17 is from 0.5 to 10 parts by weight when the total weight of the charge generation materials is 100 parts. When an organic sulfur-containing antioxidant is included in the charge transport layer 19, the concentration of the antioxidant in the charge transport layer 19 is from 0.1 to 5 parts by weight when the total weight of the charge transport material included therein is 100 parts. When the concentration of the organic sulfur-containing antioxidant is too low, the desired effects cannot be exerted. On the contrary, when the concentration of the organic sulfur-containing antioxidant is too high, adverse effects such as increase of the residual potential of the resultant photoreceptor tend to be produced.

Other antioxidants can be used in combination with an organic sulfur-containing antioxidant. Specific examples of such antioxidants include hindered phenol compounds, hindered amine compounds, phosphorus-containing compounds, pyridine derivatives, piperidine derivatives, morpholine derivatives and the like antioxidants. Among these antioxidants, hindered phenol compounds are preferably used together with an organic sulfur-containing antioxidant.

The intermediate layer 13 may include a particulate pigment such as metal oxides, e.g., titanium oxides, aluminum oxides, silica, zirconium oxides, tin oxides, indium oxides and the like; and silane coupling agents, titanium coupling agents, chromium coupling agents, titanyl chelate compounds, zirconium chelate compounds, titanylalkoxide compounds, and organic titanyl compounds to prevent occurrence of moiré in recorded images and to decrease the residual potential of the resultant photoreceptor.

The intermediate layer 13 can also be formed by any one of the methods mentioned above for use in the photoconductive layer, i.e., by coating a coating liquid in which one or more of the pigments mentioned above are dispersed in a proper solvent, if desired, together with a binder resin using a proper coating method, and drying the coated liquid. In addition, an aluminum trioxide (Al₂O₃) layer formed by an anodic oxidation method can be used as the intermediate layer 13. Further, a layer of an organic material such as polyparaxylilene and the like or an inorganic material such as SiO₂, SnO, TiO, ITO, CeO and the like, which is formed by a vacuum deposition method, can be used as the intermediate layer 13.

The thickness of the intermediate layer 13 is preferably from 0 to 10 μm.

The protective layer 21 is formed to improve the durability of the photoreceptor. Specific examples of the materials for use in the protective layer 21 include ABS resins, ACS resins, olefin-vinyl monomer copolymers, chlorinated polyethers, aryl resins, phenolic resins, polyacetal resins, polyamide resins, polyamideimide resins, polyacrylate resins, polyarylsulfone resins, polybutylene resins, polybutyleneterephthalate resins, polycarbonate resins, polyethersulfone resins, polyethylene resins, polyethyleneterephthalate resins, polyimide resins, acrylic resins, polymethylpentene resins, polypropylene resins, polyphenylene oxide resins, polysulfone resins, polystyrene resins, AS resins, butadiene-styrene copolymers, polyurethane resins, polyvinyl chloride resins, polyvinylidene chloride resins, epoxy resins and the like resins.

The protective layer 21 may include a lubricating resin such as fluorine-containing resins like polytetrafluoroethylene and silicone resins to improve the abrasion resistance of the photoreceptor. In addition, an inorganic material such as titanium oxides, tin oxides, potassium titanate and the like can be included therein to improve the abrasion resistance of the photoreceptor.

The protective layer 21 can be formed by a general coating method. The thickness of the protective layer 21 is from 0.1 to 10 μm.

In addition, a layer of amorphous carbon or amorphous silicon carbide, which is formed by a vacuum deposition method in vacuum, can also be used as the intermediate layer 13.

In the present invention, another intermediate layer (not shown in figures) may be formed between the photosensitive layer 15 (or the charge transport layer 19) and the protective layer. The intermediate layer mainly includes a resin such as polyamide resins, alcohol-soluble nylon resins, water-soluble butyral resins, polyvinyl butyral resins, polyvinyl alcohol resins and the like resins. This intermediate layer can also be formed by any one of the known coating methods as mentioned above. The thickness of such intermediate layer is preferably from 0.05 to 2 μm.

Next, the electrophotographic image forming method and apparatus of the present invention will be explained in detail referring to a drawing.

The image forming apparatus of the present invention includes at least the photoreceptor of the present invention, a charging device (process) which charges the photoreceptor, an imagewise light irradiating device (process) which irradiates the photoreceptor with imagewise light to form an electrostatic latent image on the photoreceptor, a reverse developing device (process) which develops the latent image with a developer including a toner to form a toner image on the photoreceptor, an image transfer device (process) which transfers the toner image onto a receiving material, and a cleaning device (process) which cleans the surface of the photoreceptor. Known methods and devices can be used for these devices and processes.

Namely, for example, non-contact charging devices such as corotron charging devices and scorotron charging devices utilizing corona discharging, and contact charging devices such as roller charging devices using an electroconductive roller, and brush charging devices can be used as the charging device.

In the developing process, a reversal developing method (toner adheres to the area exposed to imagewise light) using a one component developer, which may be magnetic or non-magnetic, or a two component developer can be performed.

In the image transfer process, known image transfer methods such as methods using corona charging and methods using a transfer roller can be used.

In the cleaning process, blade cleaning methods are typically used for the cleaning process. In addition, a developing device may serve as a cleaning device.

A process cartridge, which is a unit including the photoreceptor of the present invention and at least one of charging device, an imagewise light irradiating device, a developing device, a transfer device and a cleaning device and which can also be detachably installed in an electrophotographic image forming apparatus, can be used as a device unit for the image forming apparatus.

FIG. 4 is a schematic view illustrating a main part of an embodiment of the image forming apparatus of the present invention. Around the peripheral surface of a photoreceptor 31 of the present invention, a light irradiating device 32 for removing the residual potential of the photoreceptor 31, a charger 33 for charging the photoreceptor 31, an imagewise light irradiating device 35 for irradiating the photoreceptor 31 with imagewise light to form an electrostatic latent image thereon, a developing unit 36 for developing the latent image with a developer including a toner to form a toner image on the photoreceptor 31, a transfer/separation unit 40 for transferring the toner image onto a receiving material, and a cleaning unit 44 for cleaning the photoreceptor 31, are provided in this order.

As mentioned above, the photoreceptor of the present invention can particularly exhibit good performance when used in an image forming apparatus performing a contact charging process. One of the reasons therefor is mentioned above in the second paragraph of the Detailed Description of the Invention. In addition, another reason is considered to be that even when a contact charging material is used, the photoreceptor of the present invention is hardly contaminated by the contact charging element, namely the photoreceptor is hardly affected by the volatile gasses generated by the molded contact charging element and/or materials bled from the contact charging element.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### (Formation of Intermediate Layer)

The following components were mixed and dispersed for 72 hours using a ball mill to prepare an intermediate layer coating liquid.

| | |
|---|---|
| Titanium dioxide | 70 |
| (tradenamed as CR-EL and manufactured by Ishihara Sangyo | |
| Kaisha Ltd., a Japanese company) | |
| Alkyd resin | 15 |
| (Tradenamed as Bekkolite M6401-50-S and manufactured by | |
| Dainippon Ink and Chemicals, Inc., a Japanese company, | |
| solid content of 50% by weight) | |
| Melamine resin | 10 |
| (Tradenamed as Super Bekkamin L-121-60 and manufactured | |
| by Dainippon Ink and Chemicals, Inc., solid content of | |
| 60% by weight) | |
| Methyl ethyl ketone | 100 |

The thus prepared intermediate layer coating liquid was coated on the peripheral surface of an aluminum drum having a diameter of 30 mm and a length of 340 mm, and dried for 20 minutes at 130° C. to form an intermediate layer having a dry thickness of 3 μm.

### (Formation of Charge Generation Layer)

The following components were mixed and dispersed for 72 hours using a ball mill to prepare a dispersion.

| Symmetric bisazo pigment having the following | 4.0 |
|---|---|
| formula (IV) | |
| | (IV) |
| 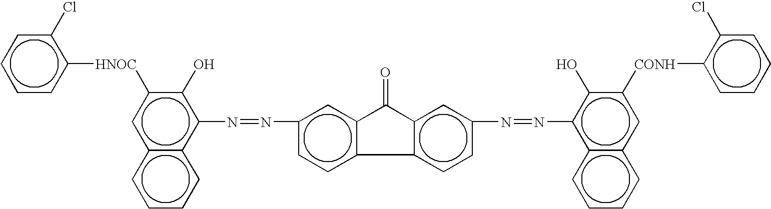 | |
| Trisazo pigment having the following formula (V) | 3.0 |

| | |
|---|---|
| | (V) |
| 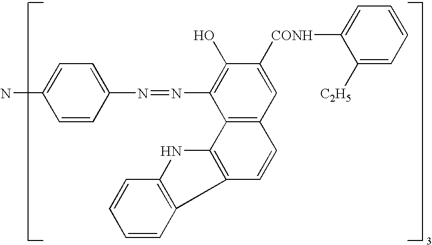 | |

| | |
|---|---|
| Polyvinyl butyral solution | 151.4 |

(1.4 parts by weight of S-lec BM-S which was manufactured by Sekisui Chemical Co., Ltd., was dissolved in 150 parts by weight of cyclohexanone)

Then the dispersion was mixed with 210 parts by weight of cyclohexanone, and additionally dispersed by the ball mill for 3 hours to prepare a charge generation layer coating liquid.

The thus prepared charge generation layer coating liquid was coated on the above-prepared intermediate layer and dried for 10 minutes at 130° C. to form a charge generation layer having a dry thickness of 0.20 μm.

### (Formation of Charge Transporting Layer)

The following component were mixed and dissolved to prepare a charge transporting layer coating liquid.

| | |
|---|---|
| Charge transport material having the following | 7.5 |
| formula (VI) | |

| | |
|---|---|
| | (VI) |
| 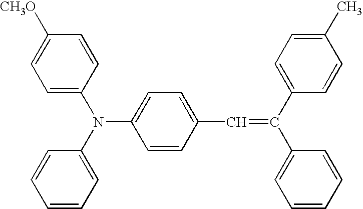 | |

| | |
|---|---|
| Z type polycarbonate | 10 |
| (viscosity average molecular weight of 40,000) | |
| Organic sulfur-containing compound having | 0.07 |
| formula (III-8) | |
| Silicone oil | 0.002 |
| (Tradenamed as KF-50 and manufactured by Shin-Etsu | |
| Chemical Co., Ltd., a Japanese company) | |
| Toluene | 100 |

The thus prepared charge transport layer coating liquid was coated on the above-prepared charge generation layer, and dried for 25 minutes at 135° C. to form a charge transport layer having a dry thickness of 28 μm.

Thus, a drum-shaped functionally-separated multilayer type photoreceptor of the present invention was prepared.

### Example 2

The procedure for preparation of the photoreceptor in Example 1 was repeated except that the organic sulfur-containing compound in the charge transport layer coating liquid was replaced with the organic sulfur-containing compound having formula (III-5).

Thus, a photoreceptor of the present invention was prepared.

### Comparative Example 1

The procedure for preparation of the photoreceptor in Example 1 was repeated except that the organic sulfur-containing compound was removed from the charge transport layer coating liquid.

Thus, a comparative photoreceptor was prepared.

### Comparative Example 2

The procedure for preparation of the photoreceptor in Example 1 was repeated except that the organic sulfur-containing compound in the charge transport layer coating liquid was replaced with a phenolic antioxidant, 2,6-di-t-butyl-p-cresol.

Thus, a comparative photoreceptor was prepared.

Each of the photoreceptors prepared in Examples 1-2 and Comparative Examples 1-2 was evaluated by the following method:

### (1) Image Qualities

A photoreceptor was set in a digital copier IMAGIO MF250M (manufactured by Ricoh Co., Ltd.), in which a filter having a ND of 0.5 was provided in imagewise light irradiating device so that the quantity of light was reduced by half.

A continuous copying test, in which an image including lack solid images whose area was 5% in the image was reproduced 50,000 times, was performed under a condition of 25° C. and 50% RH. The reproduced images were visually observed to determine whether there are undesirable images such as decrease of image density and background fouling. In addition, the reproduced images were visually observed to determine whether there are black spots. It is defined that an image has black spots when black spots having a size greater than 0.1 mm are present in the background of the image in an amount of not less than 1 piece per one square centimeter.

### (2) Light Resistance

A photoreceptor was set in the digital copier IMAGIO MF250M, in which a filter having a ND of 0.5 was provided in imagewise light irradiating device so that the quantity of light was reduced by half. At first the potential VD (−V) at an area of the photoreceptor which was not exposed to imagewise light was measured using a potential meter. The charging conditions were controlled so that the value of the potential VD was about −900 V while controlling the voltage applied to the charger. Then the photoreceptor was removed from the copier and exposed to light of 1000 lux radiated from a fluorescent lamp for 60 minutes. The photoreceptor was set again in the copier, and the potential VD′ at an area of the photoreceptor which was not exposed to imagewise light, was also measured, namely, the potential of the photoreceptor after the light irradiation test was measured. The light resistance of the photoreceptor was evaluated by [symbol] VD (i.e., VD′-VD).

The results are shown in Table 12.

TABLE 12

| | [symbol] VD | | Undesired |
|---|---|---|---|
| | (V) | Black spots | images |
| Example 1 | 170 | Black spots | none |
| | | were observed | |
| | | from 30,000^{th} | |
| | | image | |
| Example 2 | 140 | Black spots | none |
| | | were observed | |
| | | from 35,000^{th} | |
| | | image | |
| Comparative | 280 | Black spots | Background |
| Example 1 | | were observed | fouling |
| | | from 20,000^{th} | |
| | | image | |
| Comparative | 260 | Black spots | Background |
| Example 2 | | were observed | fouling |
| | | from 23,000^{th} | |
| | | image | |

### Example 3

The procedure for preparation of the photoreceptor in Example 1 was repeated except that the trisazo pigment in the charge generation layer coating liquid was replaced with 3.0 parts by weight of a τ-form metal-free phthalocyanine pigment.

Thus, a photoreceptor of the present invention was prepared.

### Example 4

The procedure for preparation of the photoreceptor in Example 3 was repeated except that the organic sulfur-containing compound in the charge transport layer coating liquid was replaced with the sulfur-containing compound having formula (III-6).

Thus, a photoreceptor of the present invention was prepared.

### Comparative Examples 3

The procedure for preparation of the photoreceptor in Example 3 was repeated except that the organic sulfur-containing compound was removed from the charge transport layer coating liquid.

Thus a comparative photoreceptor was prepared.

### Comparative Example 4

The procedure for preparation of the photoreceptor in Example 3 was repeated except that the organic sulfur-containing compound in the charge transport layer coating liquid was replaced with a phenolic antioxidant, 2,6-di-t-butyl-p-cresol.

Thus, a comparative photoreceptor was prepared.

Each of the thus prepared photoreceptors of Examples 3 and 4 and comparative photoreceptors of Comparative Examples 3 and 4 was evaluated by the same method as performed with respect to the photoreceptor in Example 1.

The results are shown in Table 13.

TABLE 13

| | [symbol] VD | | Undesired |
|---|---|---|---|
| | (V) | Black spots | images |
| Example 3 | 100 | Black spots | None |
| | | were observed | |
| | | from 41,000^{th} | |
| | | image | |
| Example 4 | 80 | Black spots | None |
| | | were observed | |
| | | from 45,000^{th} | |
| | | image | |
| Comparative | 180 | Black spots | Background |
| Example 3 | | were observed | fouling |
| | | from 27,000^{th} | |
| | | image | |
| Comparative | 160 | Black spots | Background |
| Example 4 | | were observed | fouling |
| | | from 30,000^{th} | |
| | | image | |

### Example 5

The procedure for preparation of the photoreceptor in Example 1 was repeated except that the symmetric disazo pigment was replaced with an asymmetric disazo pigment having the following formula (VII) and the trisazo pigment was replaced with a τ-form metal-free phthalocyanine pigment.

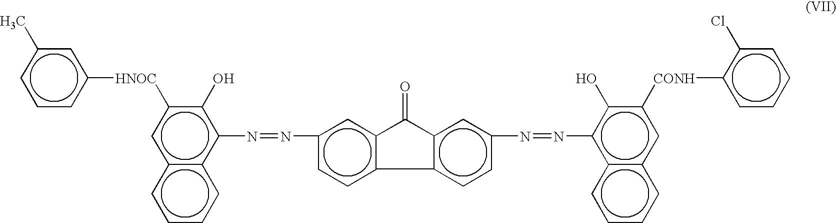

Thus a photoreceptor of the present invention was prepared.

### Examples 6 to 16

The procedure for preparation of the photoreceptor in Example 5 was repeated except that the asymmetric disazo pigment, phthalocyanine pigment and organic sulfur-containing compound were replaced with the compounds as shown in Table 14, respectively.

Thus, eleven photoreceptors of the present invention were prepared.

TABLE 14

| | Asymmetric | Phthalo- | Organic sulfur- |
|---|---|---|---|
| | Bisazo | cyanine | containing |
| | Pigment | Pigment | compound |
| Ex. 6 | Compound having | τ-form | Compound having |
| | formula (VII) | phthalo- | formula (S-3) |
| | | cyanine | |
| Ex. 7 | Compound having | τ-form | Compound having |
| | formula (VII) | phthalo- | formula (III-3) |
| | | cyanine | |
| Ex. 8 | Compound having | τ-form | Compound having |
| | formula (VII) | phthalo- | formula (III-6) |
| | | cyanine | |
| Ex. 9 | Compound having | X-form | Compound having |
| | formula (VII) | phthalo- | formula (S-1) |
| | | cyanine | |
| Ex. 10 | Compound having | X-form | Compound having |
| | formula (VII) | phthalo- | formula (S-3) |
| | | cyanine | |
| Ex. 11 | Compound having | X-form | Compound having |
| | formula (VII) | phthalo- | formula (III-5) |
| | | cyanine | |
| Ex. 12 | Compound having | X-form | Compound having |
| | formula (VII) | phthalo- | formula (III-6) |
| | | cyanine | |
| Ex. 13 | Compound having | τ-form | Compound having |
| | formula (VIII) | phthalo- | formula (S-3) |
| | | cyanine | |
| Ex. 14 | Compound having | τ-form | Compound having |
| | formula (VIII) | phthalo- | formula (S-2) |
| | | cyanine | |
| Ex. 15 | Compound having | τ-form | Compound having |
| | formula (VIII) | phthalo- | formula (III-4) |
| | | cyanine | |
| Ex. 16 | Compound having | τ-form | Compound having |
| | formula (VIII) | phthalo- | formula (III-6) |
| | | cyanine | |

### Comparative Examples 5 to 16

The procedure for preparation of the photoreceptor in Example 5 was repeated except that the asymmetric bisazo pigment, phthalocyanine pigment and organic sulfur-containing compound were replaced with the compounds as shown in Table 15, respectively.

Thus eight comparative photoreceptors were prepared.

TABLE 15

| | | | An additive |
|---|---|---|---|
| | | | replacing the |
| | Asymmetric | Phthalo- | organic sulfur- |
| | Bisazo | cyanine | containing |
| | Pigment | Pigment | compound |
| Comp. Ex. 5 | Compound having | τ-form | Not added |
| | formula (VII) | phthalo- | |
| | | cyanine | |
| Comp. Ex. 6 | Compound having | τ-form | 2,6-di-t-butyl- |
| | formula (VII) | phthalo- | p-cresol |
| | | cyanine | |
| Comp. Ex. 7 | Compound having | τ-form | 4,4′- |
| | formula (VII) | phthalo- | butylidenenbis- |
| | | cyanine | (6-t-butyl-3- |
| | | | methyl phenol) |
| Comp. Ex. 8 | Compound having | τ-form | tris(2,4-di-t- |
| | formula (VII) | phthalo- | butylphenyl) |
| | | cyanine | Phosphite |
| Comp. Ex. 9 | Compound having | X-form | Not added |
| | formula (VII) | phthalo- | |
| | | cyanine | |
| Comp. Ex. | Compound having | X-form | 2,6-di-t-butyl- |
| 10 | formula (VII) | phthalo- | p-cresol |
| | | cyanine | |
| Comp. Ex. | Compound having | X-form | 4,4′- |
| 11 | formula (VII) | phthalo- | butylidenenbis- |
| | | cyanine | (6-t-butyl-3- |
| | | | methyl phenol) |
| Comp. Ex. | Compound having | X-form | tris(2,4-di-t- |
| 12 | formula (VII) | phthalo- | butylphenyl) |
| | | cyanine | Phosphite |
| Comp. Ex. | Compound having | τ-form | Not added |
| 13 | formula (VIII) | phthalo- | |
| | | cyanine | |
| Comp. Ex. | Compound having | τ-form | 2,6-di-t-butyl- |
| 14 | formula (VIII) | phthalo- | p-cresol |
| | | cyanine | |
| Comp. Ex. | Compound having | τ-form | 4,4′- |
| 15 | formula (VIII) | phthalo- | butylidenenbis- |
| | | cyanine | (6-t-butyl-3- |
| | | | methyl phenol) |
| Comp. Ex. | Compound having | τ-form | Tris(2,4-di-t- |
| 16 | formula (VIII) | phthalo- | butylphenyl) |
| | | cyanine | Phosphite |

At this point, formula (VIII) is as follows:

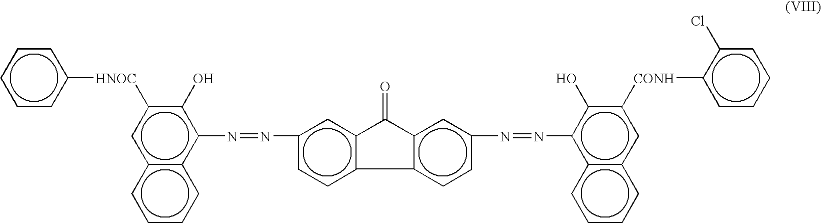

Each of the thus prepared photoreceptors of Examples 5 to 16 and comparative photoreceptors of Comparative Examples 5 to 16 was evaluated by the same method as performed with respect to the photoreceptor in Example 1.

The results are shown in Table 16.

TABLE 16

| | [symbol] VD | | Undesired |
|---|---|---|---|
| | (V) | Black spots | images |
| Example 5 | 50 | Not observed | None |
| Example 6 | 50 | Not observed | None |
| Example 7 | 20 | Not observed | None |
| Example 8 | 20 | Not observed | None |
| Example 9 | 55 | Not observed | None |
| Example 10 | 60 | Not observed | None |
| Example 11 | 20 | Not observed | None |
| Example 12 | 25 | Not observed | None |
| Example 13 | 50 | Not observed | None |
| Example 14 | 50 | Not observed | None |
| Example 15 | 20 | Not observed | None |
| Example 16 | 20 | Not observed | None |
| Comparative | 100 | Black spots | Background |
| Example 5 | | were observed | fouling |
| | | from 38,000^{th} | |
| | | image | |
| Comparative | 90 | Black spots | None |
| Example 6 | | were observed | |
| | | from 40,000^{th} | |
| | | image | |
| Comparative | 95 | Black spots | None |
| Example 7 | | were observed | |
| | | from 39,000^{th} | |
| | | image | |
| Comparative | 100 | Black spots | None |
| Example 8 | | were observed | |
| | | from 37,000^{th} | |
| | | image | |
| Comparative | 105 | Black spots | Background |
| Example 9 | | were observed | fouling |
| | | from 35,000^{th} | |
| | | image | |
| Comparative | 95 | Black spots | None |
| Example 10 | | were observed | |
| | | from 39,000^{th} | |
| | | image | |
| Comparative | 95 | Black spots | None |
| Example 11 | | were observed | |
| | | from 38,000^{th} | |
| | | image | |
| Comparative | 100 | Black spots | None |
| Example 12 | | were observed | |
| | | from 36,000^{th} | |
| | | image | |
| Comparative | 105 | Black spots | Background |
| Example 13 | | were observed | fouling |
| | | from 38,000^{th} | |
| | | image | |
| Comparative | 95 | Black spots | None |
| Example 14 | | were observed | |
| | | from 40,000^{th} | |
| | | image | |
| Comparative | 95 | Black spots | None |
| Example 15 | | were observed | |
| | | from 40,000^{th} | |
| | | image | |
| Comparative | 105 | Black spots | None |
| Example 16 | | were observed | |
| | | from 38,000^{th} | |
| | | image | |

As can be understood from Tables 15 and 16, the photoreceptors of the present invention have good charge stability even after exposed to light, and can produce good images without undesired images such as background fouling and black spots even when used for a long time.

Having now fully described the invention, it will be apparent to one of ordinary skill in the art that man changes and modifications can be made thereto without departing from the spirit and scope of the invention as set forth therein.

This application is based on Japanese Patent Application No. 11-284760, filed on Oct. 5, 1999, And Japanese Patent Application No. 11-284618, filed on Oct. 5, 1999, the entire contents of each of which being hereby incorporated by reference.

1: An electrophotographic image forming apparatus, comprising:
an electrophotographic photoreceptor;
a charging device which charges the photoreceptor;
a light irradiation device which irradiates the charged photoreceptor to form an electrostatic latent image on the photoreceptor;
a developing device which reversely develops the electrostatic latent image with a developer including a toner, to form a toner image on the photoreceptor;
an image transfer device which transfers the toner image to a receiving material; and
a cleaning device which cleans the photoreceptor, wherein the electrophotographic photoreceptor comprises an electroconductive substrate, and a photosensitive layer on the electroconductive substrate, wherein the photosensitive layer comprises at least two charge generation materials which have spectral sensitivity in differing wavelength regions, and wherein the photosensitive layer further comprises an organic sulfur-containing compound.

2: The image forming apparatus according to claim 1, wherein the charge generation materials comprise a phthalocyanine pigment and an asymmetric bisazo pigment having the following formula (I):
Cp₁-N═N-A-N═N-Cp₂ (I)
wherein A represents a divalent group having a carbon atom which connects the nitrogen atoms of the adjacent azo groups; and Cp₁ and Cp₂ each, independently, represent a residual group of a coupler, wherein Cp₁ is different from Cp₂.

3: The image forming apparatus according to claim 2, wherein the phthalocyanine pigment and the asymmetric bisazo pigment are present in the photosensitive layer in a ratio of 1:5 to 5:1 by weight.

4: The image forming apparatus according to claim 2, wherein the asymmetric bisazo pigment comprises a compound having the following formula (II): 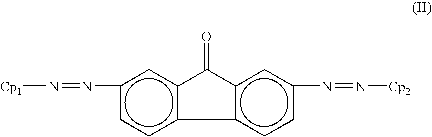
wherein Cp₁ and Cp₂ each, independently, represent a residual group of a coupler, wherein Cp₁ is different from Cp₂.

5: The image forming apparatus according to claim 2, wherein the phthalocyanine pigment comprises at least one of a τ-form metal-free phthalocyanine pigment or an X-form metal-free phthalocyanine pigment.

6: The image forming apparatus according to claim 5, wherein the phthalocyanine pigment comprises a τ-form metal-free phthalocyanine pigment having an X-ray diffraction spectrum in which main peaks are observed at Bragg 2θ angle of 7.6°, 9.2°, 16.8°, 17.4°, 20.4°, 20.9°, 21.7° and 27.6° when a specific X-ray of Cu-Kα having a wavelength of 1.541 Å irradiates the pigment.

7: The image forming apparatus according to claim 5, wherein the phthalocyanine pigment comprises an X-form metal-free phthalocyanine pigment having an X-ray diffraction spectrum in which main peaks are observed at Bragg 2θ angle of 7.5°, 9.1°, 16.7°, 17.3°, 22.3° and 28.8° when a specific X-ray of Cu-Kα having a wavelength of 1.541 Å irradiates the pigment.

8: The image forming apparatus according to claim 1, wherein the organic sulfur-containing compound comprises a compound having the following formula (III):
S—(CH₂CH₂COOCₙH₂ₙ₊₁)₂ (III)
wherein n is an integer of from 8 to 25.

9: The image forming apparatus according to claim 1, wherein the photosensitive layer further comprises a charge generation layer and a charge transport layer formed on the charge generation layer and including a charge transport material, wherein the charge generation layer comprises the charge generation materials and the charge transport layer comprises the organic sulfur-containing compound.

10: The electrophotographic image forming apparatus according to claim 1, wherein the charging device charges the photoreceptor while contacting the photoreceptor.

11: An electrophotographic process cartridge comprising:
a photoreceptor; and
at least one device selected from the groups consisting of:
a charging device which charges the photoreceptor;
a light irradiation device which irradiates the charged photoreceptor to form an electrostatic latent image on the photoreceptor;
a developing device which reversely develops the electrostatic latent image with a developer including a toner to form a toner image on the photoreceptor;
an image transfer device which transfers the toner image to a receiving material; and
a cleaning device which cleans the photoreceptor, wherein the photoreceptor comprises an electroconductive substrate, and a photosensitive layer on the electroconductive substrate, wherein the photosensitive layer comprises at least two charge generation materials which have spectral sensitivity in differing wavelength regions, and wherein the photosensitive layer further comprises an organic sulfur-containing compound.
